(19) United States
(12) Patent Application Publication
(10) Pub. No.: US 2021/0402645 A1
(43) Pub. Date: Dec. 30, 2021

(54) METHOD FOR MACHINING, IN PARTICULAR SEVERING, AT LEAST ONE CONCRETE PART

(71) Applicant: Progress Holding A.G., Brixen (IT)

(72) Inventor: Karl ENDERES, Brixen (IT)

(21) Appl. No.: 17/474,876

(22) Filed: Sep. 14, 2021

Related U.S. Application Data
(63) Continuation of application No. PCT/EP2020/054499, filed on Feb. 20, 2020.

(30) Foreign Application Priority Data
Mar. 15, 2019 (AT) A 50225/2019

(51) Int. Cl. B28B 11/12; B28B 11/16; B28D 7/00

(52) U.S. Cl. CPC B28B 11/12; B28D 7/005; B28B 11/166

(57) ABSTRACT

A method of machining at least one concrete part includes providing at least one concrete part; applying at least one marking to the at least one concrete part; arranging at least one machining device for machining the at least one concrete part relative to the at least one concrete part; detecting the at least one marking by at least one marking detection device and transmitting the marking data thus generated to the at least one machining device; and machining the at least one concrete part using the generated marking data by the at least one machining device.

The invention concerns a method of machining, in particular severing, at least one concrete part and a method of producing at least one precast concrete product.

The invention further concerns an arrangement for machining, in particular severing, at least one concrete part.

Methods and arrangements of the kind set forth in the opening part of this specification are already part of the state of the art and are shown for example in EP 2 944 736 A1.

The state of the art often involves using laser measuring devices together with data for machining a concrete part. When a plurality of concrete parts which are arranged in a row and which originate from an extrusion are machined along that laser measurement arrangement or are cut off the extrusion, cumulative errors can occur after a number of machining operations along the extrusion.

In other words, the accuracy of machining progressively deteriorates with increasing distance along the concrete part produced by an extruder. Inter alia the following factors contribute thereto: inaccuracies in the laser, inaccuracies in the data, shrinkage upon drying of the concrete and inaccuracies on the part of the operating personnel carrying out the machining operation.

In addition, there is also the problem that markings which are applied shortly after casting of the extrusion and which are intended for example to mark places to be machined (cut lines, etc . . . ) are no longer exactly correct upon drying of the concrete due to shrinkage. This often only involves millimeters, which is certainly tolerated in the building industry. Nonetheless it makes a negative impression if the marking is at a different location from the cut edge—even if only minor deviations are involved.

The markings can be applied to the concrete part by plotters. Those plotters operate with digital data. The data have to be brought into conformity with the laser measurement and also with the machining apparatus which finally machines the concrete part, and that is not the case in the state of the art. Due to the shrinkage for example it may be that the machining apparatus (for example a saw) which is controlled by way of digital data does not correctly move to the markings which were applied hours in advance. Laser measurement is also no longer correct for example because of the shrinkage.

The object of the invention is to avoid the above-described disadvantages and to provide a method which is improved over the state of the art of machining at least one concrete part, an improved method of producing at least one precast concrete product and an improved arrangement for machining, in particular severing, at least one concrete part.

In the method according to the invention that is achieved by the features of claims 1 and 13 and in the arrangement according to the invention by the features of claim 14.

The method allows improved machining of at east one concrete part when the following working steps are included:
there is provided at least one concrete part, preferably, produced by means of an extruder or slipform production apparatus,
at least one marking is applied to the at least one concrete part. preferably by means of an automatic marking apparatus and/or manually,
at least one machining apparatus, preferably, a cutting apparatus, for machining the at least one concrete part, is arranged relative to the at least one concrete part,
the at least one marking is detected by means of at least one marking detection apparatus and the marking data generated in that case are transmitted to the at least one machining apparatus, and
the at least one concrete part is machined using the generated marking data by means of the at least one machining apparatus.

Cumulative errors can be excluded by virtue of the fact that the at least one marking can be detected by a marking detection apparatus and the marking data generated in that case can be communicated to the at least one machining apparatus. Machining is therefore effected only when the marking detection apparatus receives confirmation by the marking.

Accordingly, the machining apparatus is positioned or actuated not just by the additional data, in other words the construction data of the at least one concrete part, but also by the data of the marking (marking data).

Thus for example a cut or another machining operation beside or remote from the marking can be excluded. Machining is effected exactly at the location which was also marked. The machining apparatus however can also directly move to the marking without additional data and implement the machining operation at the marked location.

It can thus be provided that in a further method step the additional data is compared to the marking data. In the comparison operation the accuracy of the position of the at least one machining apparatus is increased.

The additional data is checked by the at least one machining apparatus until the marking is found by the marking detection apparatus. Machining is then effected. That therefore provides for quick and precise positioning of the at least one machining apparatus relative to the at least one concrete part.

When comparing the additional data and the marking data, a kind of self-monitoring is involved in machining of the concrete parts. That self-monitoring can be effected substantially fully automatically by virtue of the digital detection.

It can be provided that the additional data is provided by a central control device and communicated, preferably by way of at least one data transmission apparatus, to the at least one machining apparatus, preferably wirelessly, and/or by means of at least one data memory, for example a USB stick. That therefore provides for a quick and thus also economical machining by the at least one machining apparatus as same is not moved manually to the position to be machined but for example travels fully automatically on the concrete part to be machined.

It can thus be provided that the at least one machining apparatus, on the basis of the additional data, moves to the at least one marking, there the at least one marking is detected by the marking detection apparatus and transmitted to the machining apparatus. Both data sets—the additional data and the marking data—are used together to cause the at least one machining apparatus to operate at the correct position. If the marking data for example do not match the additional data, no machining operation is carried out.

It can also be provided that rough positioning of the at least one machining apparatus is effected by the additional data, while fine positioning is effected by way of the marking detection apparatus on the basis of the markings arranged on the concrete part—thus by means of the detected marking data.

It has proven to be advantageous if the at least one marking is in the form of a reference marking which is used for a portion of the at least one concrete part, preferably, wherein the portion of the at least one concrete part has precisely one reference marking.

If only one reference point is set at the beginning of an extrusion, a summation of errors and tolerances occurs in the machining step, which makes itself noticeable in particular in relation to the last precast concrete products machined or produced on the extrusion. If each individual precast concrete product is provided with its own reference point in the form of a reference marking, r cumulative errors are prevented, as the at least one machining apparatus receives separate measurement values or data for each concrete part to be machined, based on that individual reference marking.

Accordingly, the marking detection apparatus can find a separate reference point for each individual concrete part to be machined, and that prevents cumulative errors along the concrete part which is cast in the form of an extrusion. in the state of the art in most cases only one laser measurement was carried out starting from a point (reference point) at the beginning of the extrusion—cumulative errors are provoked in that way.

It is advantageous if the at least one marking includes at least one line and/or two-dimensional shape. Depending on the respective implementation of the marking detection apparatus it can be recognized in that way. In addition, the marking can also include data which are recognized by the marking detection apparatus (for example codes like bar codes, QR codes, etc . . . ). The markings however can also be only simple cut lines, along which a cut is to be produced by a saw. The marking can also be adapted to any kind of machining which is carried out by the at least one machining apparatus.

It has proven to be advantageous if the at least one marking is applied by the application of at least one marking paint to the at least one concrete part, preferably, wherein the at least one marking paint includes luminophore particles.

Luminophore particles are particles which emit light after they have been previously excited for example with shorter-wave light, by ionizing radiation or chemically, The phenomenon is based on phosphorescence, fluorescence or chemoluminescence. It is appropriate if the at least one marking detection apparatus is adapted to emit and/or receive light which is invisible or visible to the human eye.

A particularly advantageous mode of operation can for example provide that the at least one marking detection apparatus emits visible or invisible light which is reflected by the at least one marking.

Alternatively or additionally, it can be provided that the light emitted by the at least one marking detection apparatus, for example in the form of UV light, excites particles in the at least one marking, for example by fluorescence or phosphorescence, to emit light which is detected by the at least one marking detection apparatus.

It does not necessarily have to be provided however that the at least one marking detection apparatus emits visible or invisible light. The prevailing ambient light may also already be sufficient to make the at least one marking detectable for the at least one marking detection apparatus.

It can also be provided that the marking is invisible to the naked eye and is recognized only by the marking detection apparatus. The marking can also be applied by a fluorescing dye or a dye which lights up in some other fashion to provide for better visibility or detection.

If the at least one marking detection apparatus is arranged at the at least one machining apparatus and is also moved therewith, then direct processing of the detected data by the machining apparatus can be effected. That avoids error sources or inaccuracies.

For improved machining of a concrete part and/or improved customization cutting of a concrete part it has proven to be advantageous if the at least one machining apparatus
includes at least one travel measuring apparatus, preferably at least one rotary encoder, with which the travel distance covered by the at least one machining apparatus relative to the at least one concrete part is measured, and/or
has at least one data receiving apparatus, by way of which additional data for positioning the at least one machining apparatus relative to the at least one concrete part and/or for machining the at least one concrete part by the at least one machining apparatus are received, and/or
has at least one processor-controlled data processing apparatus, by way of which the at least one machining apparatus is controlled, and/or
has at least one drive apparatus, with which the at least one machining apparatus is moved relative to the at least one concrete part, and/or
has at least one cutting tool, with which the at least one concrete part is severed at at least one predetermined position,

The travel measuring apparatus makes it possible to provide for additional monitoring of the position and the distance traveled of the machining apparatus, which can be brought into relationship with the additional data and/or the marking data in order for example to be able to carry out data matching for more efficient machining or also simply stopping machining in the case of an error. That matching operation can be carried out for example by a data processing apparatus.

According to a further aspect of the invention, there is provided a method of producing at least one precast concrete product, in particular at least one hollow ceding, wherein the at least one precast concrete product is obtained by means of the method of machining, in particular severing, at least one concrete part, according to the above-stated method steps, from the at least one concrete part.

According to a further aspect of the invention, there is provided an arrangement for machining, in particular severing, at least one concrete part, in particular at least one extruded profile for the production of a precast concrete product like for example a hollow ceiling, wherein the arrangement is designed and adapted to machine, in particular sever, the at least one concrete part according to the above-depicted method, wherein the arrangement has at least one machining apparatus for machining the at least one concrete part.

By that arrangement precast concrete products or concrete parts can be produced more easily, more accurately and more efficiently.

When applying such an arrangement, a kind of self-monitoring can be effected in machining of the concrete parts. That self-monitoring can be effected substantially fully automatically on the basis of digital detection.

If the arrangement
has at least one extruder or slipform production apparatus for the production of the at least one concrete part, and/or
has at least one automatic marking apparatus for applying at least one marking to the at least one concrete part,
   production and subsequently marking of the at least one concrete part can be effected quickly and in an automated procedure and thus preparation can also be implemented for an efficient and accurate machining.

Efficient and accurate machining can be effected if the arrangement has at least one marking detection apparatus for detection of at least one marking applied to the concrete part, preferably, wherein
the at least one marking detection apparatus is arranged at the at least one machining apparatus, and/or
is adapted to emit and/or receive light which is invisible or visible to the human eye, and/or
is adapted to detect at least one line and/or two-dimensional shape.

In that respect it can be provided that the at least one machining apparatus
includes at least one travel measuring apparatus, preferably at least one rotary encoder, with which the travel distance covered by the at least one machining apparatus relative to the at least one concrete part can be measured, and/or
has at least one data receiving apparatus, by way of which additional data for positioning the at least one machining apparatus relative to the at least one concrete part and/or for machining the at least one concrete part by the at least one machining apparatus are receivable, and/or
has at least one processor-controlled data processing apparatus, by way of which the at least one machining apparatus can be controlled, and/or
has at least one drive apparatus, with which the at least one machining apparatus is movable relative to the at least one concrete part, and/or has at least one cutting tool, with which the at least one concrete part can be severed at at least one predetermined position.

Further monitoring of the positioning of the machining apparatus can be effected by the additional travel measuring apparatus. All the data from the travel measuring apparatus as well as the additional data and also the marking data can be used individually or cooperatively in the data processing apparatus, like for example compared, in order to make machining of the precast concrete parts still more efficient and accurate and/or to permit automated movement or machining procedures.

For that purpose, it can also be provided that the arrangement includes a central control device, wherein additional data for positioning the at least one machining apparatus relative to the at least one concrete part and/or for machining the at least one concrete part by the at least one machining apparatus can be provided by the central control device, preferably, wherein the arrangement has at least one data transmission apparatus, with which the additional data can be communicated to the at least one machining apparatus, preferably wirelessly, and/or by means of at least one data memory, for example a USB stick.

Further details and advantages of the present invention will be described in more details hereinafter by means of the specific description with reference to the embodiments by way of example illustrated in the drawings in which:

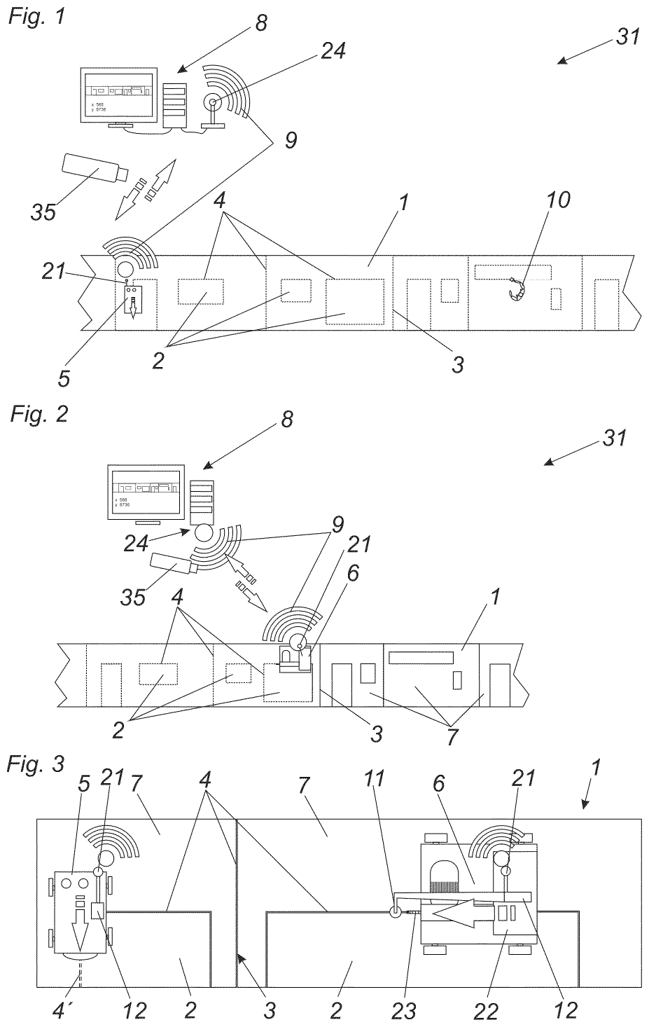

FIG. 1 shows a diagrammatic view of the application of the markings,

FIG. 2 shows a diagrammatic view of the machining operation,

FIG. 3 shows a detailed diagrammatic view of marking and machining,

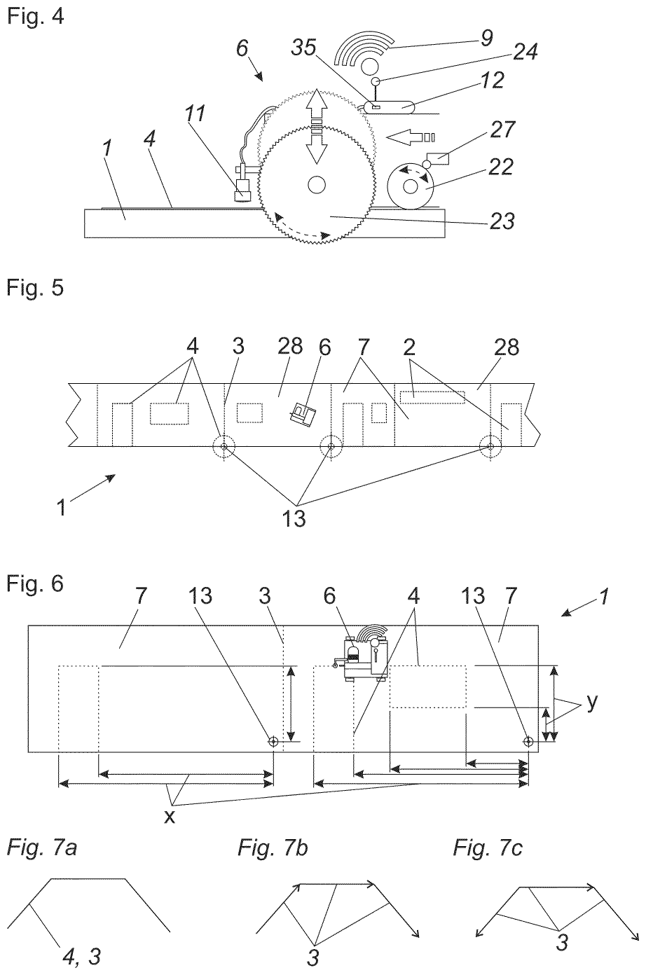

FIG. 4 shows a diagrammatic view of a severing apparatus (saw) as an example of a machining apparatus,

FIG. 5 shows a diagrammatic view of reference markings,

FIG. 6 shows a diagrammatic view of reference markings with dimensions or data relating to further machining,

FIGS. 7a 7c show a diagrammatic view of the machining sequence,

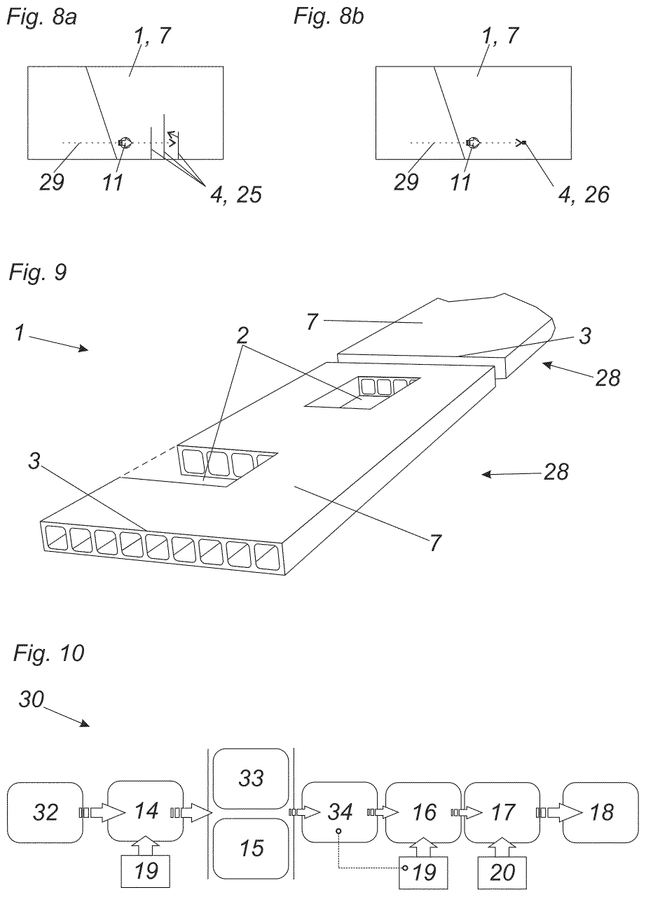

FIGS. 8a, 8b show a diagrammatic view of marking detection,

FIG. 9 shows a diagrammatic view of a precast concrete product, and

FIG. 10 shows a diagrammatic view of a method of processing a concrete part to give a precast concrete product.

FIG. 1 shows an arrangement 31 and a concrete part 1 which are marked by markings 4 at the locations to be machined by a marking apparatus 5, preferably a self-propelled data-controlled plotter. Those locations to be machined can be cut-outs 2, customization cuts 3 or also other, for example informative markings 4 like for example dimensional specifications, advertising imprints, indications or the like.

Instead of a marking apparatus 5 or in addition to the marking apparatus 5, a person 10 can also apply, supplement, remove or modify markings 4 if that is necessary.

The marking apparatus 5 can receive data, preferably additional data 19 in the form of construction data (like for example PXML data, CAD data, vector graphics, etc, . . . ) from a control device 8 and also send data back to the control device 8 by way of a data transmission line 9. By virtue of that data transmission line 9 the marking apparatus 5 can preferably fully automatically apply the markings 4 to the concrete part 1.

The data transmission 9 can be effected by way of a data transmission apparatus 24 at the control device 8 and a data reception apparatus 21 at the marking apparatus 5 either wirelessly and/or via cable and/or by way of a data memory 35. For example a USB stick can serve as the data memory 35.

FIG. 2 shows the arrangement 31 and a machining apparatus 6 which detects the previously applied markings 4 and travels to machine the marked regions of the concrete part 1. Here, it is possible, to create for example portions 7, by individual segments being cut out of the entire extruded product at a customization cut line 3. Cut-outs 2 like for example window openings are cut out.

The machining apparatus 6 can for example be a severing apparatus (saw), a polishing apparatus, a grinding apparatus, a setting apparatus for formworks, a boring or milling apparatus, an embossing apparatus, a cleaning or brushing apparatus or other apparatuses from the state of the art.

The machining apparatus 6 can receive data, preferably additional data 19 in the form of construction data (like for example PXML data, CAD data, vector graphics, etc . . . ) from a control device 8 and also send them back to the control device 8 by way of a data transmission 9. The machining apparatus 6 can preferably fully automatically carry out the machining operation on the concrete part 1 by virtue of that data transmission 9.

The data transmission 9 can be effected by way of a data transmission apparatus 24 at the control device 8 and a data reception apparatus 21 at the machining apparatus 6 either wirelessly and/or via cable and/or by way of a data memory 35. For example a USB stick can serve as the data memory 35.

FIG. 3 shows in detail how a concrete part 1 is marked by a marking apparatus 5, preferably a self-propelled data-controlled plotter, at the locations to be machined, by means of markings 4. That is effected by way of the additional data 19 from the control device 8. The markings 4′ which are predetermined by the additional data 19 but which are not yet printed are checked by the marking apparatus 5 and made into detectable markings 4.

In the next method step and/or also parallel thereto, the preferably self-propelled and automated at least one machining apparatus 6 can move to the markings 4 and carry out the desired machining operation. Detection of the markings 4 is effected by way of the marking detection apparatus 11 which is preferably formed by a sensor like a shape recognition sensor and/or an image sensor.

The data of the marking detection apparatus 11 is processed or converted to marking data 20 in a data processing apparatus 12. The data processing apparatus 12 can also receive the additional data 19 and compare same to the obtained marking data 20 to be able to exclude errors or to be able to have the machining apparatus perform more precise machining. In an emergency situation in the event of a difference between the marking data 20 and the additional data 19, a machining operation can also be stopped in order not to produce waste.

The machining apparatus 6 can have its own drive apparatus 22 which permits an autonomous displacement of the machining apparatus 6 on the surface to be machined. In that respect it is guided or controlled by the markings 4 and/or the additional data 19.

In the case shown in FIG. 3 the machining apparatus 6 can have a cutting tool 23 which makes it possible to cut or sever the underlying stratum—in this case the concrete part 1.

Instead of a cutting tool 23 however it would also be possible to provide other tools like for example a concrete suction device, a drilling or milling head, a brush, a grinding head or another tool known from the state of the art or also combinations thereof. It is also possible to provide a plurality of tools, preferably driven, on a machining apparatus 6. The machining apparatus 6 can also be an industrial robot which can be versatile in use and which is preferably moveably in mobile fashion on or over the concrete parts.

FIG. 4 shows as an example of a machining apparatus 6 a severing apparatus having a cutting tool 23—preferably a driven saw blade. The cutting tool 23 cuts in an automated procedure into the concrete part 1, wherein the machining apparatus 6 can be displaced on the precast concrete part 1 by a drive device 22. In that case displacement and cutting is effected along the marking 4 which is detected by the marking detection apparatus 11. For that purpose the detected data of the marking detection apparatus 11 are passed to the data processing apparatus 12. That is connected to the drive device 22 and the drive of the cutting tool 23 and can control same. In addition, there can be provided a travel measuring apparatus 27 which can detect the distance covered and thus also the position of the machining apparatus 6. The data obtained in that case is also passed to the data processing apparatus 12.

Connected to the data processing apparatus 12 is the data transmission apparatus 24 which produces the data transmission 9 to the control device 8. Data can also be transmitted by means of data memories 35.

FIG. 5 shows how a separate reference marking 13 can be provided for each individual portion 7 of the concrete cast in the extrusion form. In other words each precast concrete product 28 can have its own reference marking 13, from which the further markings 4, for example for customization cuts 3 or cut-outs 4 and/or machining by the machining apparatus 6 start. By those reference markings 13 cumulative errors or deviations upon progressive machining of the extruded element are minimized or prevented.

FIG. 6 shows in detail how the markings 4 were created, starting from the reference marking 13, by way of x and/or y values. Each portion 7 which will form a future precast concrete product 28 has its own reference marking 13 from which the data sets start as x values and/or y values for the markings 4 of that portion. Thus each portion 7 is communicated only the values tailor-made for it, in the form of additional data 19, which prevents cumulative errors or deviations. Those deviations would occur if at the beginning of the extrusion, there would be only one reference point from which the entire machining operation in respect of the individual portions 7 is effected.

FIG. 7a shows a cut-out 3 in a concrete part, as is to be produced by a saw. That can be carried out in two different ways.

The displacement of the machining apparatus 6 does not always have to take place in the same direction as the displacement of the marking apparatus 4. If the machining apparatus 6—in the example in FIGS. 7a to 7c—is displaced in the same direction as previously the marking apparatus 5, as the same data (additional data 19) are used, it can happen that the saw blade has to vary between same-direction cut and opposite-direction cut (direction of cut of the saw blade with or in opposite relationship to the direction of advance of the saw). Here, increased wear can occur at the tool, which would be the case with FIG. 7b. With the ongoing change in the machining apparatus 6 in order to minimize wear, that is to say to select an optimum direction of cut, it can be that more time has to be allowed. That is shown in FIG. 7c. The cycle times can thus be prolonged.

In order to find a compromise between wear and cycle times, the machining apparatus 6, when approaching the markings 4 to produce the customization cuts 3, can for example block out the additional data 19 and only orient itself to the markings 4 in order to select a suitable machining procedure (correct direction of cut or orientation).

A person, too, can make that decision on the basis of the markings 4 on site and accordingly adapt the machine to the markings 4.

Generally, in such a case it is possible to decide whether the cut or the machining operation should be carried out on the basis of the additional data 19 and/or on the basis of the markings 4.

FIG. 8a shows detection of the markings 4 in this case formed by lines by the marking detection apparatus 11. It travels along a detection movement 29 until it detects a marking 4 in the form of at least one line 25. Depending on the respective configuration of the marking detection apparatus 11, one or more lines 25 have to be applied in order to be able to guarantee a reaction on the part of the marking detection apparatus 11. Normal sensors often require a plurality of lines as a reference in order to be able to respond. That is shown in FIG. 8a by the individual arrows.

FIG. 8b shows a “hybrid sensor” as the marking detection apparatus 11, which is capable of recognizing two-dimensional shapes 26 like circles, rectangles, QR codes and so forth. Here, there is no need to approach a plurality of lines 25 as shown in FIG. 8a.

FIG. 9 shows a precast concrete product 28, in this embodiment a hollow ceiling in the form of an extruded profile, preferably tried-and-tested or prestressed (reinforced concrete). At the cuts 3 the individual portions 7 which constitute the precast concrete products 28 after definitive machining are cut out of the extruded profile. Cut-outs 2 can also be provided. In the case of a hollow ceiling they are for example shaft passages, staircases, chimney openings or the like.

Hollow profiles like the precast concrete product 28 can however also be used as wall elements, in which case the cut-outs 2 can be provided for example for doors or windows.

The method 30 or the arrangement 31 provides that the production of precast concrete products 28, with which complete buildings can be erected, is greatly simplified, as the precast concrete products 28 can be produced efficiently and with a high level of accuracy.

FIG. 10 shows the method steps in the method 30. Beginning with the “provision -concrete part 32” in which the concrete part 1 is prepared for further machining. That can be effected for example by extrusion casting.

The marking operation 14 follows as the next step, possibly under the influence of the additional data 19 which can cause the marking apparatus 5 to apply the markings 4 in an automated procedure. The reference markings 13 can also be applied in that case.

The further step is the “provision -machining apparatus 33” in which the association of the machining apparatus 6 on the concrete part 1 is implemented. The machining apparatus 6 can move for example by way of a ramp onto the concrete part 1, it can be fitted thereon with a crane, and so forth. The “provision—machining apparatus 33” can already be effected under the influence of the additional data 19 so that the machining apparatus 6 assumes a kind of readiness position on the concrete part 1 in an automated procedure. It is, however, also possible that an operator carrys out a simple manual positioning 15 of the machining apparatus 6.

It can, however, also be provided that the machining apparatus 6 does not move directly on the concrete part but for example on rails arranged beside the concrete part. In that case the machining apparatus 6 can be arranged on an arm or a cantilever beam provided on a rail-mounted carriage. The machining apparatus 6 can move relative to the rail-mounted carriage and thus at the same time relative to the concrete part in order to machine the concrete part.

The next step is the “provision—data 24”, wherein in this case the additional data 19 is used which include the construction of the precast concrete product 28. In this step, the additional data 19 is transmitted to the machining apparatus 6 by way of the above-mentioned options.

The machining apparatus 6 places itself on the basis of the additional data 19 in the step “approach—data 16” and, this way, already begins to look for a marking 4 by the marking detection apparatus 11.

When that marking 4 is found, the step “positioning—marking data 17” is effected, in which the machining apparatus orients itself by means of the markings 4 in order to then cause the machining operation to be implemented at the marked position. In that case, as already indicated above, a comparison can be made between the marking data 20 and the additional data 19 in order to achieve more accurate machining or, in case of a difference between the two sets of data, to prevent machining in order to minimize wastage.

The machining operation 18 is effected as a further step, preferably, in the form of a cutting operation using a saw device. After the machining operation 18, further steps can be provided in order to be able to finish the precast concrete product 28.

### LIST OF REFERENCES

1 concrete part
2 cut-out
3 customization cut
4 marking (4′ is a notional broken-line marking predetermined by a database)
5 marking apparatus (preferably, self-propelled plotter, data-controlled, automated)
6 machining apparatus (preferably, severing apparatus like a self-propelled saw, data controlled, automated)
7 portion
8 control device (computer with data transmission device)
9 data transmission
10 person
11 marking detection apparatus (preferably, sensor, shape detection and/or line detection sensor)
12 data processing apparatus
13 reference marking
14 marking operation
15 manual positioning of the saw (if necessary)
16 approach data
17 automated positioning marking data 20
18 machining operation, preferably cutting operation
19 additional data (PXML data, CAD data, vector graphics data, . . . from database to control device 8)
20 marking data (from the detection apparatus 11)
21 data receiving apparatus
22 drive device
23 cutting tool
24 data transmission apparatus
25 line
26 two-dimensional shape
27 travel measuring apparatus
28 precast concrete product
29 detection movement
30 method
31 arrangement
32 provision of concrete part
33 provision of machining apparatus
34 provision of data
35 data memory

1. A method of machining, in particular severing, at least one concrete part, in particular at least one extruded profile for the production of a precast concrete product like for example a hollow ceiling,
comprising the following method steps:
there is provided at least one concrete part preferably produced by means of an extruder or slipform production apparatus,
at least one marking is applied to the at least one concrete part, preferably by means of an automatic marking apparatus and/or manually,
at least one machining apparatus, preferably a cutting apparatus, for machining the at least one concrete part, is arranged relative to the at least one concrete part,
the at least one marking is detected by means of at least one marking detection apparatus and the marking data generated in that case are transmitted to the at least one machining apparatus, and
the at least one concrete part is machined using the generated marking data by means of the at least one machining apparatus.

2. The method as set forth in claim 1, wherein in a further method step additional data are provided for positioning the at least one machining apparatus relative to the at least one concrete part and/or for processing the at least one concrete part by the at least one machining apparatus, wherein the at least one concrete part is machined using those additional data by means of the at least one machining apparatus.

3. The method as set forth in claim 2, wherein the additional data involve construction data of the at least one concrete part and/or the precast concrete product to be produced.

4. The method as set forth in claim 2, wherein the additional data are compared to the marking data in a further method step.

5. The method as set forth claim 2, wherein the additional data is provided by a central control device and transmitted, preferably by way of at least one data transmission apparatus, to the at least one machining apparatus, preferably wirelessly, and/or by means of at least one data memory, for example a USB stick.

6. The method as set forth in claim 1, wherein the at least one marking marks at least one region of the concrete part, that is to be machined by the at least one machining apparatus, preferably at least one cut-out or at least one customization cut.

7. The method as set forth in claim 1, wherein the at least one marking is in the form of a reference marking which is used for a portion of the at least one concrete part, preferably wherein the portion of the at least one concrete part has precisely one reference marking.

8. The method as set forth in claim 1, wherein the at least one marking includes at least one line and/or two- dimensional shape.

9. The method as set forth in claim 1, wherein the at least one marking is applied by the application of at least one marking paint to the at least one concrete part, preferably wherein the at least one marking paint includes luminophore particles.

10. The method as set forth in claim 1, wherein the at least one marking detection apparatus is adapted to emit and/or receive light which is invisible or visible to the human eye.

11. The method as set forth in claim 1, wherein the at least one marking detection apparatus is arranged at the at least one machining apparatus and also moves with the at least one machining apparatus.

12. The method set forth in claim 1, wherein the at least one machining apparatus
includes at least one travel measuring apparatus, preferably at least one rotary encoder, with which the travel distance covered by the at least one machining apparatus relative to the at least one concrete part is measured, and/or
has at least one data receiving apparatus, by way of which additional data for positioning the at least one machining apparatus relative to the at least one concrete part and/or for machining the at least one concrete part by the at least one machining apparatus is received, and/or
has at least one processor-controlled data processing apparatus, by way of which the at least one machining apparatus is controlled, and/or
has at least one drive apparatus, with which the at least one machining apparatus is moved relative to the at least one concrete part, and/or
has at least one cutting tool, with which the at least one concrete part is severed at at least one predetermined position.

13. A method of producing at least one precast concrete product, in particular at least one hollow ceiling, wherein the at least one precast concrete product is obtained by means of the method of machining, in particular severing, at least one concrete part, as set forth in claim 1, from the at least one concrete part.

14. An arrangement for machining, in particular severing, at least one concrete part, in particular at least one extruded profile for the production of a precast concrete product, like for example a hollow ceiling, wherein the arrangement is designed and adapted to machine, in particular sever, the at least one concrete part according to the method as set forth in claim 1, wherein the arrangement has at least one machining apparatus for machining the at least one concrete part.

15. The arrangement as set forth in claim 14, wherein the arrangement
has at least one extruder or slipform production apparatus for the production of the at least one concrete part, and/or
has at least one automatic marking apparatus for applying at least one marking to the at least one concrete part.

16. The arrangement as set forth in claim 14, wherein the arrangement has at least one marking detection apparatus for detection of at least one marking applied to the concrete part, preferably wherein
the at least one marking detection apparatus is arranged at the at least one machining apparatus, and/or
is adapted to emit and/or receive light which is invisible or visible to the human eye, and/or
is adapted to detect at least one line and/or two-dimensional shape.

17. The arrangement as set forth in claim 14, wherein the at least one machining apparatus
includes at least one travel measuring apparatus, preferably at least one rotary encoder, with which the travel distance covered by the at least one machining apparatus relative to the at least one concrete part can be measured, and/or
has at least one data receiving apparatus, by way of which additional data for positioning the at least one machining apparatus relative to the at least one concrete part and/or for machining the at least one concrete part by the at least one machining apparatus is receivable, and/or
has at least one processor-controlled data processing apparatus, by way of which the at least one machining apparatus is controllable, and/or
has at least one drive apparatus e with which the at least one machining apparatus is movable relative to the at least one concrete part, and/or
has at least one cutting tool, with which the at least one concrete part can be severed at at least one predetermined position.

18. The arrangement as set forth in claim 14, wherein the arrangement includes a central control device, wherein additional data for positioning the at least one machining apparatus) relative to the at least one concrete part and/or for machining the at least one concrete part by the at least one machining apparatus can be provided by the central control device preferably wherein the arrangement has at least one data transmission apparatus, with which the additional data can be communicated to the at least one machining apparatus, preferably wirelessly, and/or by means of at least one data memory, for example a USB stick.
